(19) United States
(12) Patent Application Publication
(10) Pub. No.: US 2002/0111703 A1
(43) Pub. Date: Aug. 15, 2002

(54) Musician's practice recorder

(76) Inventor: James M. Cole, Frederick, MD (US)

Correspondence Address: Larry J. Guffey, World Trade Center - Suite 1800, 401 East Pratt Street, Baltimore, MD, 21202, US

(21) Appl. No.: 09/734,533

(22) Filed: Feb. 12, 2001

(51) Int. Cl. G06F 17/00; G10L 11/00

(52) U.S. Cl. 700/94; 704/270; 704/500

(57) ABSTRACT

The present invention discloses an audio recorder that is especially useful for musicians. In a preferred embodiment, such a recorder provides a user with: (a) a generous amount of recording and playback time, (b) a means for repeating the playback of selected segments of a recording, (c) cueing as to when a selected portion of a recording will begin, (d) an audible metronome during recording and playback by imputing beats into a recording, (e) the ability to slow down or speed up the tempo of the playback of a recording, (f) a jack for plugging in external speakers or connecting the recorder to an external computer, (g) operation of the recorder from a rechargeable internal battery pack or through an external A/C transformer, and (h) a housing which easily clips onto a standard music stand.

### CROSS-REFERENCE TO RELATED APPLICATIONS

This application is related to the following U.S. Provisional Patent Application: Application No.______, filed Oct. 24, 2000, entitled “Tapeless Self-Contained Practice Recorder,” by applicant James Cole. The teachings of this application are incorporated herein by reference to the extent that they do not conflict with the teaching herein.

### BACKGROUND OF THE INVENTION

1. Field of the Invention

The present invention relates to data processing and the recording and playback of sound. More particularly, this invention relates to a device that provides a means to capture and playback sound with the use of digital technology for the purpose of music practice.

2. Description of the Related Art

Within recent years, new applications have enabled musicians to record music through the use of digital technology, thus doing away with the utilization of magnetic tape as the sole means for music recording. Commercial applications of this new technology generally have been limited to devices that capture and save to semiconductor memory only short durations of music (e.g., ninety seconds or less), or those devices that save the music on a compact (CD) or optical disc. See U.S. Pat. Nos. 6076,063, 5,837,912, 5,787,399, and 5,511,000.

In the case of those devices that save to semiconductor memory, the sound quality is often poor and their limited playback time mean that such recorders can only be utilized for phrases or short sections of music. For CD and optical writing recorders, the music cannot be played back immediately. In addition, these recorders use mechanical parts; therefore, they are inherently fragile, and the cost to the consumer to purchase, maintain, and use the accessories associated with them (e.g., blank compact discs) are relatively high.

Traditional tape recording devices are also limited in that the tape must be rewound in order for the music to be played back from start to finish, thus limiting the utility of the device. And unless an external microphone is attached to a tape recorder, and even then, the sound quality is poor at best.

Additionally, other musician's tools such, as a metronome, are not a feature of these devices. Thus, an external metronome must be employed for the use of keeping time. Nor is there a way to continually loop the captured sound for repeated and continuous playback.

All of these devices, while useful for some things, are not satisfactory in all areas that are of importance to musicians. Thus, there is a need for a simple, easy to operate, self-contained, portable practice recorder.

Such an improved recorder could be employed in many useful way; for example: (1) for recording of a part to a duet, (2) to aid instructors in critiquing students during a lesson and immediately after a piece has been played, or (3) to aid an ensemble musician by allowing other ensemble member's parts to be recorded and played back later to enable a single ensemble player to practice when the other members are not present.

### SUMMARY OF THE INVENTION

The present invention is generally directed to satisfying the needs set forth above and overcoming the limitations and problems identified with prior recorders.

In accordance with one preferred embodiment, the present invention in its most basic form comprises: (a) a means for recording sound, (b) a means for playing back the recorded sound, (c) a means for marking time during the recording at regular, adjustable time intervals, and (d) a means for cueing a user of the recorder during play back as to when a specified portion of the recording is to begin.

Some of these elements are seen to provide features of the present invention which are of unique importance to musicians who use such a recorder. Additionally, other embodiments of the present invention contain other features which are also especially useful for musicians who use the present invention as a practice recorder. These additional features include: (a) the use of a digitizer and digital data compression methods to extend the recorder's recording time so that it is suitable for longer pieces of music or the recording of more than one piece of music at a time, (b) the use of non-volatile memory which allows for relatively instant playback of the recorded sound and the ability to save a digitized recording even when the recorder is turned off or disconnected from its power source, (c) the use of control circuits and hardware which enable the recorder to: (1) loop the playback of specified segments of a recording so that such segments can be played back almost continuously, (ii) slow down and speed up the rate of playback as desired while retaining the original pitch of the music, (iii) operate the recorder via A/C power or a re-chargeable battery, and (iv) be attached to external speakers or to be plugged into a computer.

The present invention is seen to overcome the limitations of the prior art by providing a simple-to-operate, self-contained, practice recorder that integrates well into the musician's environment.

It is therefore an object of the present invention to provide a satisfactory means by which musicians and music instructors can hear a high quality recording of music just after it is played, or later as desired.

It is a further object of the present invention to provide a self-contained system of recording and practicing music that does not require additional devices or accessories.

These and other objects and advantages to the present invention will become readily apparent as the invention is better understood by reference to the accompanying drawings and the detailed description that follows.

### BRIEF DESCRIPTION OF THE DRAWINGS

FIG. 1 is a schematic block diagram of one embodiment of the present invention.

FIG. 1 is a further schematic block diagram of one embodiment of the present invention which illustrates more details of the various elements.

FIG. 3 illustrates the process of substituting metronome sounds for selected segments of a recording in order to provide a user with time markers.

FIG. 4 illustrates the process of substituting cueing sounds for selected segments of a recording in order to cue a user that a desired playback sound will commence at the end of the cueing sequence.

FIG. 5 illustrates the circuit board design and electronic components for a preferred embodiment of the present invention.

FIG. 6 illustrates the attachment of a prototype version of a preferred embodiment of the present invention to the bottom support lip of a music stand.

FIG. 7 provides a side view of the spring clips shown in FIG. 6.

FIG. 8 illustrates a prototype version of the embodiment shown in FIGS. 6-7 and which shows the recorder's housing and its control buttons, spring clips and jack. which allows the recorder to be connected to a headphone, an external amplifier or a computer.

### DESCRIPTION OF THE PREFERRED EMBODIMENT

For purposes of explanation and not limitation, specific details are set forth below, such as specific software processes, integrated circuits, housing designs, and features of the present invention. However, it will be apparent to one skilled in the art that the present invention may be practiced in other embodiments that depart from these specific details.

Additionally, it should be understood that the present invention may be applied to uses other than recording music, such as recording the spoken voice and recording other sounds not traditionally thought of as music, such as nature sounds, etc. Thus, for example, both spoken voice and other audible sounds can be effectively recorded using the present invention.

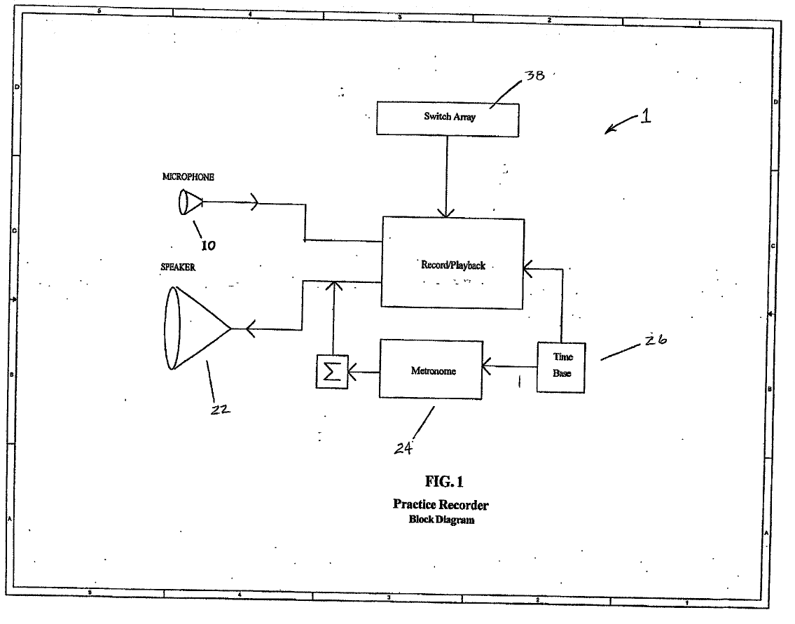

Referring to the drawings wherein are shown preferred embodiments and wherein like reference numerals designate like elements throughout, there is shown in FIG. 1 a schematic block diagram of one embodiment of the present invention. It is an audio practice recorder 1 comprising: (a) a means for recording sound, (b) a means for playing back the recorded sound, (c) a means for marking time during the recording at regular, adjustable time intervals, and (d) a means for cueing a user of the recorder during play back as to when a specified portion of the recording is to begin.

As is well known, the means for recording sound can be achieved in a variety of ways. For a preferred embodiment of the present invention, sound enters a microphone 10 and is converted to an electrical waveform. An amplifier 12 then amplifies this signal by an amount of voltage gain specific to the application at hand. This is a range pre-set to accommodate recording music at close proximity without undue attention to level settings by the user. The waveform is digitized in the incoming side of a digitizer 14 and the digital result is passed on to a host processor 16. The processor 16 performs various operation on the digitized signal and stores the digital data in a non-volatile memory 18.

The means for playing back the recorded sound essentially reverses the recording operation, except that the digital data is output through the decoder side of the digitizer 14 and is then applied to a power amplifier 20 and a speaker 22. See FIG. 2. Because the data storage is maintained either within the processor 16 (for large-cache processors) or in associated electronic memory 18, retrieval of the recorded sound is essentially immediate, thus permitting the user to get quick feedback on the sound of the recording.

In order to increase the present invention's usefulness as a musician's practice recorder, a means for marking time during a recording at regular, adjustable time intervals has been made an element of the present invention. This feature is achieved by integrating the electronic form of a metronome 24 into the present invention.

Because transferring the digital data stream from the processor 16 to the memory 18 and back is controlled with a timer or time base 26 in a read/write regime, as all such memory processes are implemented, this transfer process lends itself to the inclusion of the audible sound timing references of a metronome 24. Therefore, if is samples of, for example, hand-clapping or tapping are recorded permanently in one area of the recorder's memory 18, those samples may be played back alternately with the user's own practice work, such that the metronome sound is evenly and predictably interwoven with the practice work. This permits the recorder to integrate the metronome sounds directly with the practice work and thus give the user excellent timing feedback. The implementation of this process is done through software in the processor 16 which alternatively outputs samples from the recorded practice work, or from the metronome sampled sounds.

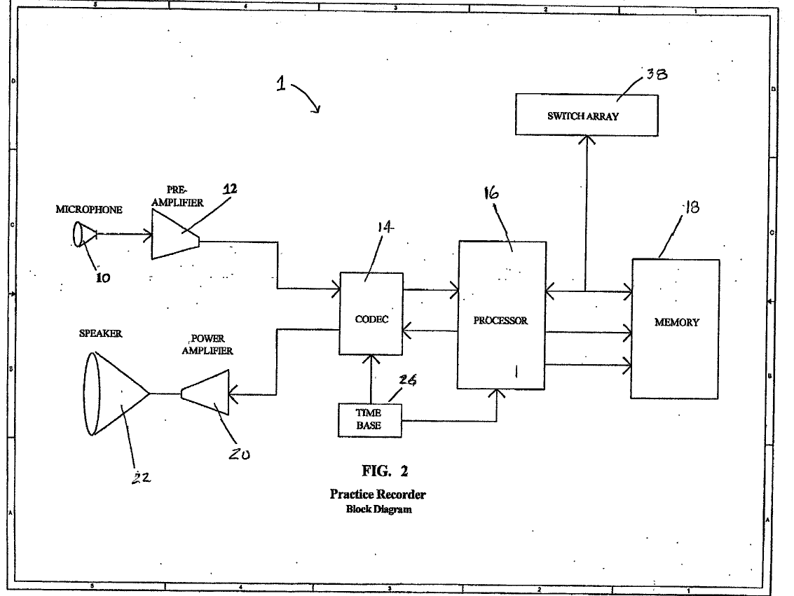

Shown in FIG. 3 is a data stream with sound samples from the user's practice work sequentially read from memory 18 into the digitizer 14. Several of the samples are seen to be replaced with the metronome data samples. As shown, the n+4 and n+5 sound samples are replaced with metronome n and n+1 samples. The sound samples then resume at the n+7 position.

During a musician's practice, especially when practicing for multi-part music, such as a duet, it is often very useful to record one of the “parts” so as to allow the musician to play along with it in the other part. To facilitate this, the present invention includes software for sending a series of “beeps” or other tones which are timed such that they match the metronome timing rate prior to playback of a recorded piece. When the user initiates a playback, there is a period during which the present invention emits these tones to cue the user that the playback sound will commence at the end of the cueing sequence.

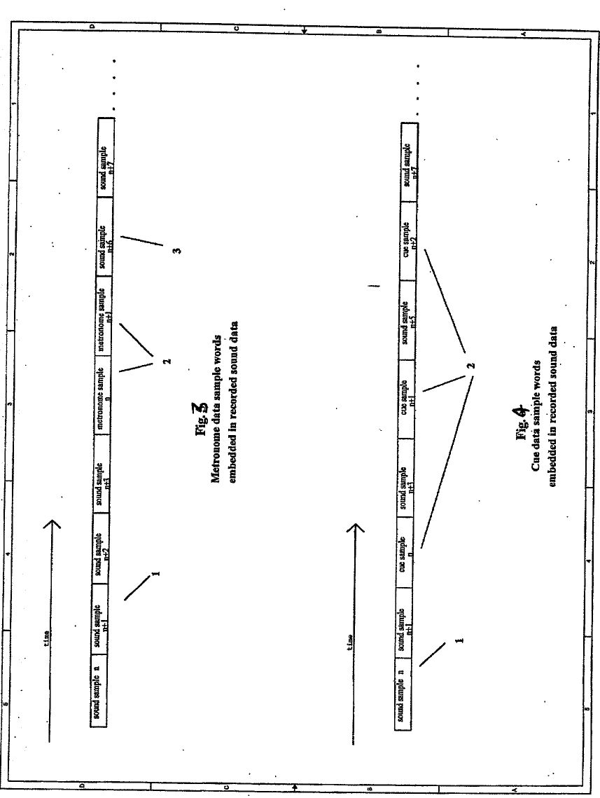

Similarly to the metronome implementation, the tone pulses are synthesized digitally and can thus be integrated directly into the digital data stream at the appropriate times. As shown in FIG. 4, several of the sound samples are replaced by cue tone samples such that the cue tone rhythm is integral to the process.

A further feature of the present invention, which has been added to aid a musician's practice, is a means of looping indefinitely the playback of a specified segment of a recording. Since the recorded sound is digitized and stored in memory, it may be read back and “played” indefinitely upon command from the processor 16 through software selection of recursive memory addresses. This feature is basic to the practice recorder utility by permitting close scrutiny of a segment of recorded practice work without having to re-wind a tape recorder.

A still further feature of the present invention is its use of a non-volatile memory 18. This allows the present invention to maintain a recorded sound while, for example, it is turned off or disconnected from its power source as it is being transported from the instructor's studio to the user's home. This feature is achieved by using a non-volatile memory, such as flash memory or battery-backed, static random access memory.

Additionally, the present invention uses data compression to economically achieve a high degree of real-time data storage capability without a loss in sound quality. The technique used involves “multi-format” coding and the compression method known as Adaptive Differential Pulse Code Modulation (ADPCM). In its basic form, ADPCM stores data such that, rather than storing the actual samples of a waveform, it stores the difference between successive samples. This leads to lower storage requirements because the difference between samples might be, for example, 3 bits. whereas the samples themselves are 16-bit words.

For the present invention, there are four “formats” of the data as it is stored.

These are as follows:

format 0=three 10-bit words with a 2-bit control

format 1=four 7- or 8-bit words with a 2-bit control

format 2=five 6-bit words with a 2-bit control

format 3=six 5-bit words with a 2-bit control

In each case, the audio data is a 30-bit word plus 2 control bits, wherein the control bits are given values 0 through 3 to indicate which format is used for each word. For samples which require longer words (widely varying dynamics in music) the format 0 is mapped, and less compression is achieved. The converse is the case during quiet passages, and small word sizes may be used. Therefore the encoding process takes measurement of the dynamic spread between samples and assigns a data format (control bits) to that sample. The data is then stored as a 32-bit word (30+2 bits). Upon playback, the decoding process examines the control bits and determines how long the data words per sample are for a given 32-bit word read from memory. In this way, the original audio data is reconstructed without loss to the original signal.

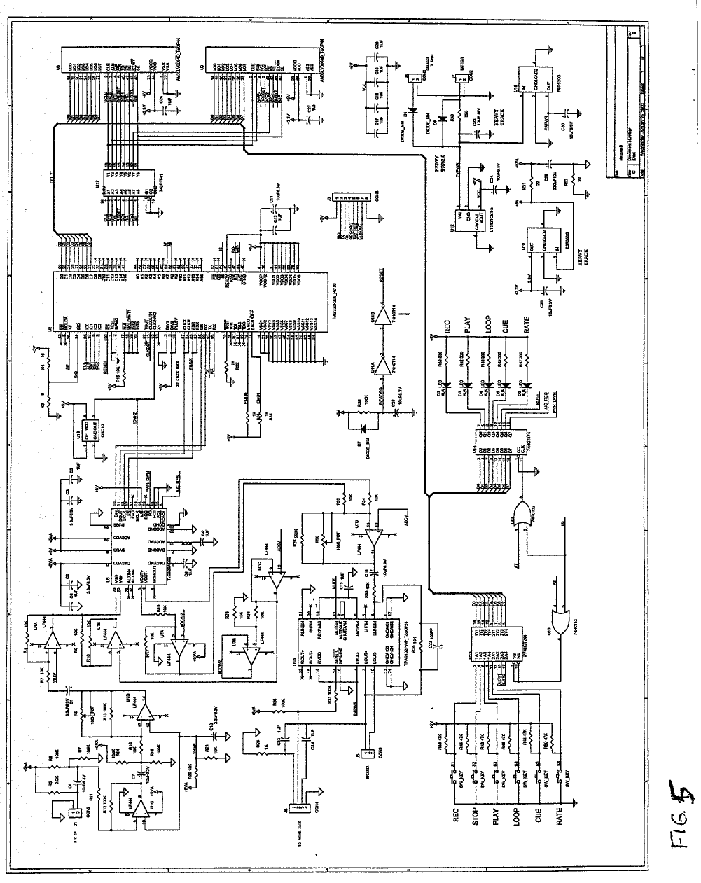

Additionally, the digital nature of the present invention allows for the easy use of software to enable the recorder to slow down and speed up the rate of playback of a musical recording as desired, while retaining the original pitch of the music. Suitable electronic components for implementing this feature and the others described above are shown in the circuit diagram of FIG. 5

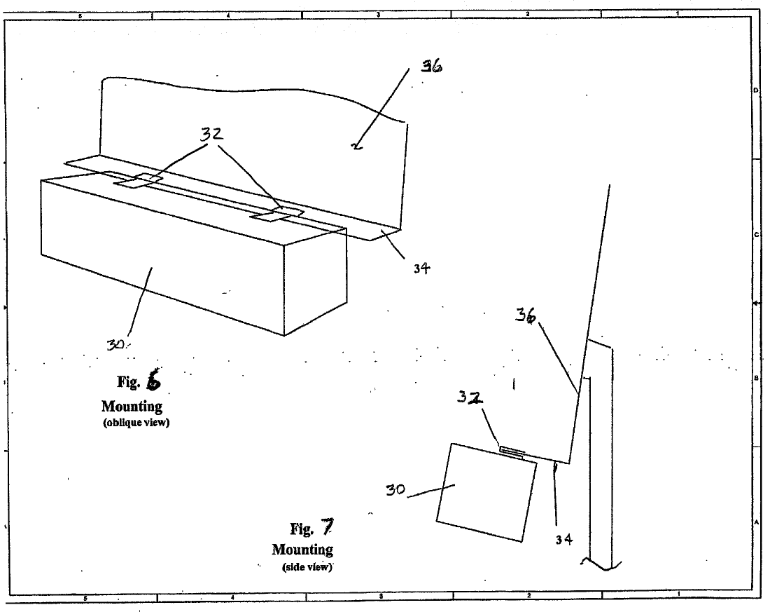

FIG. 6 shows a schematic representation of a preferred embodiment of the present invention having been attached to a music stand. Such stands generally take a relatively, standard shape and have proven to be quite useful for holding and displaying sheet music in a manner that is helpful to musicians. The housing 30 of the embodiment shown in FIG. 6 can be seen to have mounted on its exterior a pair of spring clips 32 which easily and quickly slide over the bottom, support lip 34 of the music stand 36. A side view of these clips 32 is provided in FIG. 7. The nature of these clips 32 is such that no tools or tightening, etc., is required for their attachment to a music stand 36.

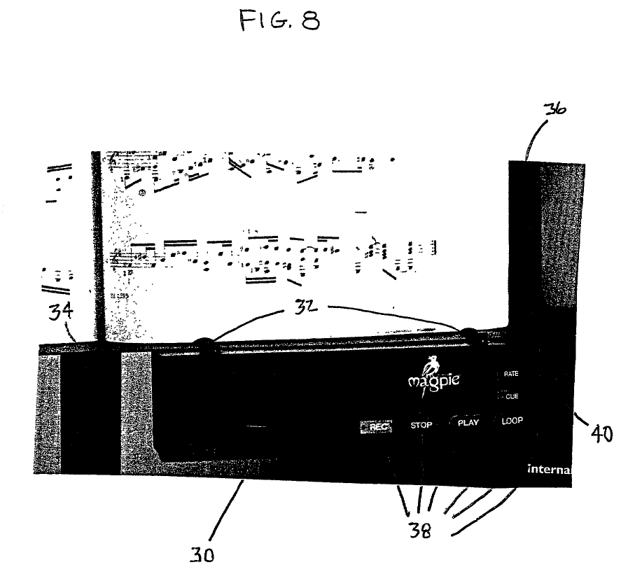

FIG. 8 shows a prototype version of the embodiment of FIGS. 6-7 which is also attached to a music stand 36 and which clearly shows the recorder's control switches 38, spring clips 32 and a jack 40 which allows the recorder 1 to be connected to a headphone, an external amplifier or an external computer.

The foregoing descriptions of the invention have been presented for purposes of illustration and description. Further, the description is not intended to limit the invention to the form disclosed herein. Consequently, variations and modifications commensurate with the above teachings, and combined with the skill or knowledge in the relevant art are within the scope of the present invention.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

I claim:

1. An audio practice recorder comprising:
a means for recording the sound present in the environment surrounding said means,
a means, coupled to said recording means, for playing back said recorded sound, and
a means, coupled to said playback means, for marking time during said recording at regular, adjustable time intervals.

2. An audio practice recorder as recited in claim 1 further comprising a means, coupled to said playback means, for cueing a user of said recorder during playback as to when a specified portion of said recording is to begin.

3. An audio practice recorder as recited in claim 2 further comprising a means, coupled to said playback means, for looping the playback of a specified portion of said recording.

4. An audio practice recorder as recited in claim 3 further comprising a means, coupled to said playback means, for varying rate of playback of said recording.

5. An audio practice recorder as recited in claim 4 further comprising a housing which encloses said means, said housing having an exterior surface having a clip which allows said recorder to be attached to the support lip of a music stand.

6. An audio practice recorder as recited in claim 5 wherein said recording means having connected in series a microphone, an amplifier, a digitizer, a processor and a non-volatile memory, with said processor having control software for compressing the digitized recording data to be stored and directing said processor to perform said marking time, cueing, looping and variable rate playback functions.

7. An audio practice recorder comprising:
a means for recording the sound present in the environment surrounding said means,
a means, coupled to said recording means, for playing back said recorded sound, and
a means, coupled to said playback means, for cueing a user of said recorder during playback as to when a specified portion of said recording is to begin.

8. An audio practice recorder as recited in claim 7 further comprising a means, coupled to said playback means, for looping the playback of a specified portion of said recording.

9. An audio practice recorder as recited in claim 8 further comprising a means, coupled to said playback means, for varying rate of playback of said recording.

10. An audio practice recorder as recited in claim 9 further comprising a housing which encloses said means, said housing having an exterior surface having a clip which allows said recorder to be attached to the support lip of a music stand.

11. An audio practice recorder as recited in claim 10 wherein said recording means having connected in series a microphone, an amplifier, a digitizer, a processor and a non-volatile memory, with said processor having control software for compressing the digitized recording data to be stored and directing said processor to perform said cueing, looping and variable rate playback functions.

12. An audio practice recorder comprising:
a means for recording the sound present in the environment surrounding said means,
a means, coupled to said recording means, for playing back said recorded sound, and
a means, coupled to said playback means, for looping the playback of a specified portion of said recording.

13. An audio practice recorder as recited in claim 12 further comprising a means, coupled to said playback means, for varying the rate of playback of said recording.

14. An audio practice recorder as recited in claim 13 further comprising a means, coupled to said playback means, for marking time during said recording at regular, adjustable time intervals.

15. An audio practice recorder as recited in claim 14 further comprising a housing which encloses said means, said housing having an exterior surface having a clip which allows said recorder to be attached to the support lip of a music stand.

16. An audio practice recorder as recited in claim 15 wherein said recording means having connected in series a microphone, an amplifier, a digitizer, a processor and a non-volatile memory, with said processor having control software for compressing the digitized recording data to be stored and directing said processor to perform said marking time, looping and variable rate playback functions.

17. An audio practice recorder comprising:
a means for recording the sound present in the environment surrounding said means,
a means, coupled to said recording means, for playing back said recorded sound, and
a means, coupled to said playback means, for varying rate of playback of said recording.

18. An audio practice recorder as recited in claim 17 further comprising a means, coupled to said playback means, for marking time during said recording at regular, adjustable time intervals.

19. An audio practice recorder as recited in claim 18 further comprising a means, coupled to said playback means, for cueing the playback of a specified portion of said recording.

20. An audio practice recorder as recited in claim 19 further comprising a housing which encloses said means, said housing having an exterior surface having a clip which allows said recorder to be attached to the support lip of a music stand.

21. An audio practice recorder as recited in claim 20 wherein said recording means having connected in series a microphone, an amplifier, a digitizer, a processor and a non-volatile memory, with said processor having control software for compressing the digitized recording data to be stored and directing said processor to perform said marking time, cueing and variable rate playback functions.

22. An audio practice recorder comprising:
a means for recording the sound present in the environment surrounding said means,
a means, coupled to said recording means, for playing back said recorded sound, and
a housing which encloses said means, said housing having an exterior surface having a clip which allows said recorder to be attached to the support lip of a music stand.

23. An audio practice recorder as recited in claim 22 further comprising a means, coupled to said playback means, for marking time during said recording at regular, adjustable time intervals.

24. An audio practice recorder as recited in claim 23 further comprising a means, coupled to said playback means, for cueing the playback of a specified portion of said recording.

25. An audio practice recorder as recited in claim 24 further comprising a means, coupled to said playback means, for looping the playback of a specified portion of said recording.

26. An audio practice recorder as recited in claim 25 wherein said recording means having connected in series a microphone, an amplifier, a digitizer, a processor and a non-volatile memory, with said processor having control software for compressing the digitized recording data to be stored and directing said processor to perform said marking time, cueing and looping playback functions.
